(19) United States
(12) Patent Application Publication
(10) Pub. No.: US 2025/0294005 A1
(43) Pub. Date: Sep. 18, 2025

(54) SOCIAL INTERACTION METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Ruijie JIANG, Shenzhen (CN); Dan HE, Shenzhen (CN); Liqiang LIU, Shenzhen (CN); Yang ZENG, Shenzhen (CN); Shu-Hui CHOU, Shenzhen (CN); Guilin XIANG, Shenzhen (CN)

(21) Appl. No.: 19/225,773

(22) Filed: Jun. 2, 2025

Related U.S. Application Data
(63) Continuation of application No. PCT/CN2024/080946, filed on Mar. 11, 2024.

(30) Foreign Application Priority Data
May 6, 2023 (CN) 202310502864.2

(51) Int. Cl. H04L 51/52; H04L 51/043; H04M 1/72439

(52) U.S. Cl. CPC H04L 51/52; H04L 51/043; H04M 1/72439

(57) ABSTRACT

This application provides a social interaction method and apparatus, an electronic device, a computer-readable storage medium, and a computer program product. The method includes displaying a status presentation area of a target account; presenting a first virtual image corresponding to a target status and a social interaction control in the status presentation area in response to a social status of the target account being the target status; transmitting social interaction invitation information to a terminal corresponding to the target social account in response to a social invitation operation on a target social account triggered by the social interaction control; and replacing the first virtual image with a second virtual image corresponding to the target status when the target social account accepts the social interaction invitation operation, the second virtual image indicating that the social relationship is established between the target account and the target social account.

### RELATED APPLICATIONS

This application is a continuation of PCT/CN2024/080946 filed on Mar. 11, 2024, which in turn claims priority to Chinese Patent Application No. 202310502864.2 filed on May 6, 2023, which are both incorporated herein by reference in their entirety.

### FIELD OF THE TECHNOLOGY

This application relates to mobile Internet technologies, and in particular, to a social interaction method and apparatus, an electronic device, a storage medium, and a program product.

### BACKGROUND OF THE DISCLOSURE

In many social networking messaging applications, a user may indicate his or her current status or actions by setting a social status of a login account, where the social status refers to a status such as online, away, busy, or offline of the login account, or another status that can express a current action of the user, such as listening to a song or messing around. Displaying a social status of a login account enables the user to learn a real-time status of a friend or a contact of the user, thereby facilitating social communication and interaction, to drive activity of a social relationship chain.

In the related technology, when a social status of a login account is displayed, the presentation is limited, and lacks scenario interaction in a social relationship, leading to low utilization of graphic processing resources in a device.

### SUMMARY

Embodiments of this application provide a social interaction method and apparatus, an electronic device, a computer-readable storage medium, and a computer program product, to add more interaction elements to a social status presentation application, thereby improving utilization of graphic processing resources.

Technical solutions of the embodiments of this application are implemented as follows.

One aspect of this application provides a social interaction method, applied to a social invitation initiating terminal, and including displaying a status presentation area of a target account, the status presentation area presenting a social status of the target account; presenting a first virtual image corresponding to a target status and a social interaction control in the status presentation area in response to a social status of the target account being the target status, the social interaction control being configured to invite at least one social account to establish a social relationship with the target account in the target status; transmitting social interaction invitation information to a terminal corresponding to the target social account in response to a social invitation operation on a target social account triggered by the social interaction control; and replacing the first virtual image with a second virtual image corresponding to the target status when the target social account accepts the social interaction invitation operation, the second virtual image indicating that the social relationship is established between the target account and the target social account in the target status.

An aspect of this application provides a social interaction method, applied to a social invitation receiving terminal, and including: displaying social interaction invitation information transmitted by a target account for a target social account in an interaction interface between the target social account and the target account, the social interaction invitation information being configured for inviting the target social account to establish a social relationship with the target account in a target status, and the target status being a current social status of the target account; and displaying interaction communication establishment indication information in response to a determining operation performed by the target social account on the social interaction invitation information, the interaction communication establishment indication information indicating that a social status of the target social account is set to the target status and establishing the social relationship between the target social account and the target account.

Another aspect of this application further provides a non-transitory computer-readable storage medium, having a computer-executable instruction or a computer program stored therein, and implementing, when executed by a processor, the social interaction method according to the embodiments of this application.

Embodiments of this application have the following beneficial effects:

By applying the embodiments of this application, a social account may be invited, by using a social interaction control, to establish a social relationship with the target account in the target status, and when the target social account receives a social interaction invitation of the target account, the first virtual image of the target account is replaced with the second virtual image. Because the second virtual image is configured to indicate that a corresponding social relationship is established between the target account and the target social account in the target status, it can be known that when the target social account receives the social interaction invitation of the target account, the social status of the target social account may be automatically set to the target status the same as that of the target account, and the social relationship established between the target social account and the target account may be presented by using the second virtual image, thereby increasing interactivity based on the social status. In addition, because the first virtual image and the second virtual image both correspond to the target status, virtual image elements are added to a social status presentation application, thereby enriching social status presentation styles, and improving utilization of graphic processing resources.

### BRIEF DESCRIPTION OF THE DRAWINGS

FIG. 1 is a schematic diagram of an architecture of a social interaction system 100 according to an embodiment of this application.

FIG. 2 is a schematic structural diagram of an electronic device 500 according to an embodiment of this application.

FIG. 3 is a schematic flowchart of a social interaction method according to an embodiment of this application.

FIG. 4 is a schematic diagram of a social status setting interface according to the embodiments of this application.

FIG. 5 is a schematic diagram of creating a virtual image according to an embodiment of this application.

FIG. 6 is a schematic diagram of creating a virtual image according to an embodiment of this application.

FIG. 7 is a schematic diagram of creating a virtual image according to an embodiment of this application.

FIG. 8 is a schematic diagram of displaying feedback prompt information according to an embodiment of this application.

FIG. 9 is a schematic flowchart of a social interaction method according to an embodiment of this application.

FIG. 10 is a schematic diagram of displaying social interaction invitation information according to an embodiment of this application.

FIG. 11 is a schematic diagram of social interaction according to an embodiment of this application.

FIG. 12 is a schematic diagram of an interaction communication establishment indication according to an embodiment of this application.

FIG. 13 is a schematic diagram of an architecture of a social interaction system according to an embodiment of this application.

FIG. 14 is a schematic diagram of a method for creating a virtual image according to an embodiment of this application.

FIG. 15 to FIG. 17 are schematic diagrams of creating a virtual image according to an embodiment of this application.

FIG. 18 is a schematic diagram of social interaction according to an embodiment of this application.

FIG. 19 is a schematic diagram of social interaction according to an embodiment of this application.

### DESCRIPTION OF EMBODIMENTS

To make the objectives, technical solutions, and advantages of this application clearer, the following further describes this application in detail with reference to the accompanying drawings. The embodiments described are not to be considered as a limitation to this application. All other embodiments obtained by a person of ordinary skill in the art without creative efforts shall fall within the protection scope of this application.

In the embodiments of this application, relevant data (for example, user data such as gender, age, educational experience, and interests and hobbies) related to user information is involved. When the embodiments of this application are applied to specific products or technologies, user permission or consent is required, and the collection, use, and processing of relevant data need to comply with relevant laws, regulations, and standards of relevant countries and regions.

In the following descriptions, related “some embodiments” describe a subset of all possible embodiments. However, the “some embodiments” may be the same subset or different subsets of all the possible embodiments, and may be combined with each other without conflict.

In the following descriptions, the related term “first, second, . . . ” is merely intended to distinguish between similar objects rather than represent a particular sequence of the objects. A particular sequence or a chronological order indicated by “first, second, . . . ” may be changed, so that the embodiments of this application described herein can be implemented in a sequence other than the sequence illustrated or described herein.

Unless otherwise defined, the meanings of all technical and scientific terms used herein are the same as those usually understood by a person skilled in the art to which this application belongs. Terms used herein are merely intended to describe the embodiments of this application, but are not intended to limit this application.

Before the embodiments of this application are further described in detail, terms involved in the embodiments of this application are described. The terms provided in the embodiments of this application are applicable to the following explanations.

(1) Client: It is an application providing various services run in the terminal, such as a social client or an instant messaging client.

(2) “In response to” is configured to represent a condition or a state/status on which an executed operation depends, and when a dependent condition or state/status is met, one or more operations executed may be in real time or has a set delay. Without being specifically stated, there is no limitation to the order in which the operations are performed.

Embodiments of this application provide a social interaction method and apparatus, an electronic device, a computer-readable storage medium, and a computer program product, to add more interaction elements to a social status presentation application, thereby improving utilization of graphic processing resources. An application of the electronic device provided in the embodiments of this application is described below. The electronic device provided in the embodiments of this application may be implemented as various types of user terminals such as a notebook computer, a tablet computer, a desktop computer, a set-top box, a mobile device (for example, a mobile phone, a portable music player, a personal digital assistant, a dedicated messaging device, or a portable game device), a smart phone, a smart speaker, a smart watch, a smart television, or an in-vehicle terminal, or may be implemented as a server. Certain applications are described below by implementing the electronic device as a terminal.

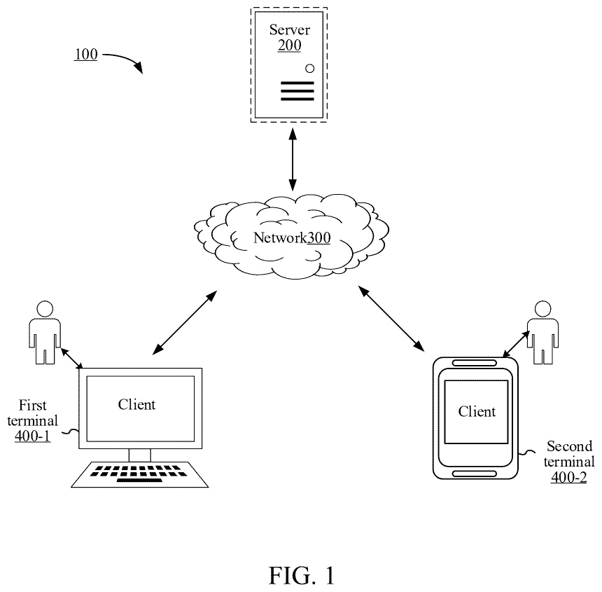

FIG. 1 is a schematic diagram of an architecture of a social interaction system 100 according to an embodiment of this application. To implement and support an application, a first terminal 400-1 and a second terminal 400-2 are connected to a server 200 by a network 300. The network 300 may be a wide area network, a local area network, or a combination of the two.

In some embodiments, the server 200 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The first terminal 400-1 and the second terminal 400-2 may each be a smartphone, a tablet computer, a notebook computer, a desktop computer, a smart speaker, a smartwatch, an in-vehicle terminal, or the like, but is not limited thereto. The first terminal, the second terminal, and the server may be connected directly or indirectly in a wired or wireless communication manner, which is not limited in embodiments of this application.

In one embodiment, the first terminal 400-1 is located in a social interaction invitation initiating terminal (that is, a terminal corresponding to a target account), and the second terminal 400-2 is located in a social interaction invitation receiving terminal (that is, a terminal corresponding to a target social account). A client such as a social client or an instant messaging client is placed on each of the first terminal 400-1 and the second terminal 400-2. When a user opens the client on the first terminal 400-1 to view a current social status of the target account, a status presentation area of the target account is displayed, where the status presentation area is configured for presenting the social status of the target account; and in response to a social status of the target account being a target status, a first virtual image corresponding to the target status and a social interaction control are presented in the status presentation area, and in response to a social invitation operation on the target social account triggered based on the social interaction control, a social interaction invitation request is transmitted to the server 200. The server 200 generates social interaction invitation information based on the social interaction invitation request, and transmits the social interaction invitation information to the second terminal 400-2 corresponding to the target social account, where the social interaction invitation information is configured for inviting the target social account to establish a social relationship with the target account in a target status. When the target social account triggers a determining operation on the social interaction invitation information, the server returns an interaction result (for example, accepting an invitation) of the target social account for the social interaction invitation information to the first terminal 400-1 corresponding to the target account, and the first terminal 400-1 corresponding to the target account replaces the first virtual image presented in the status presentation area with a second virtual image corresponding to the target status, where the second virtual image is configured to indicate that the social relationship is established between the target account and the target social account in the target status.

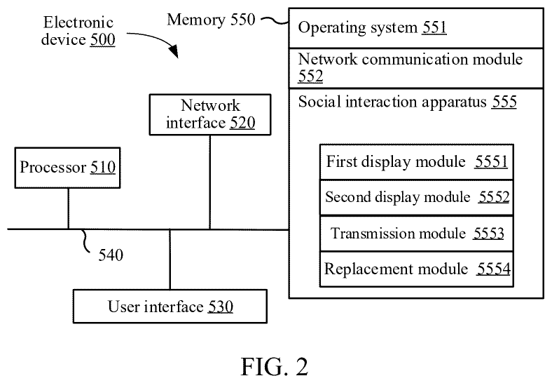

FIG. 2 is a schematic structural diagram of an electronic device 500 according to an embodiment of this application. An example in which the electronic device 500 is the first terminal 400-1 in FIG. 1 is used. The electronic device 500 shown in FIG. 2 includes: at least one processor 510, a memory 550, at least one network interface 520, and a user interface 530. Components in the electronic device 500 are coupled together through a bus system 540. The bus system 540 is configured to implement connection and communication between the components. In addition to a data bus, the bus system 540 also includes a power bus, a control bus, and a state signal bus. However, for clarity of description, all types of buses in FIG. 2 are marked as the bus system 540.

The processor 510 may be an integrated circuit chip having a signal processing capability, for example, a general purpose processor, a digital signal processor (DSP), another programmable logic device, discrete gate or transistor logic device, or discrete hardware component, or the like. The general purpose processor may be a microprocessor or any conventional processor, or the like.

The memory 550 includes a volatile memory or a non-volatile memory, and may alternatively include both volatile and non-volatile memories. The non-volatile memory may be a read-only memory (ROM). The volatile memory may be a random access memory (RAM). The memory 550 described in this embodiment of this application is to include any other suitable types of memories. The memory 550 alternatively includes one or more storage devices away from the processor 510 in physical positions.

In some embodiments, the memory 550 may store data to support various operations. Examples of the data include a program, a module, and a data structure, or a subset or a superset thereof, which are described below by using examples.

An operating system 551 includes system programs for processing various basic system services and performing hardware-related tasks, such as a framework layer, a kernel library layer, and a drive layer, and is configured to implement various basic services and process hardware-based tasks. A network communication module 552 is configured to reach other electronic devices via one or more (wired or wireless) network interfaces 520. An example of the network interface 520 includes: Bluetooth, wireless fidelity (Wi-Fi), universal serial bus (USB), and the like.

In some embodiments, a social interaction apparatus provided in an embodiment of this application may be implemented in a software manner. A social interaction apparatus provided in an embodiment of this application may be provided as various software embodiments, including various forms such as an application, software, a software module, a script, or code. FIG. 2 shows a social interaction apparatus 555 that is stored in the memory 550. The social interaction apparatus may be software in the form of a program, a plug-in, or the like, and include a series of modules: including a first display module 5551, a second display module 5552, a transmission module 5553, and a replacement module 5554. These modules are logical and may be combined in different manners or further split according to a function to be implemented. function of each module is described below.

In some other embodiments, the apparatus provided in embodiments of this application may be implemented by hardware. As an example, the apparatus provided in embodiments of this application may be a processor in the form of a hardware decoding processor, programmed to perform the social interaction method provided in embodiments of this application. For example, the processor in the form of the hardware decoding processor may use one or more application specific integrated circuits (ASIC), a digital signal processor (DSP), a DSP, a programmable logic device (PLD), a complex programmable logic device (CPLD), a field-programmable gate array (FPGA), or other electronic components.

In some embodiments, the terminal or the server may implement the social interaction method provided in the embodiments of this application by running various computer-executable instructions or computer programs. For example, the computer-executable instruction may be a microprogram-level command, a machine instruction, or a software instruction. The computer program may be an original program or a software module in an operating system; may be a native application (APP), namely, a program that needs to be installed in the operating system to run, such as an instant messaging APP; or may be a mini program that can be embedded into any APP, namely, a program that only needs to be downloaded into a browser environment to run. In a word, the foregoing computer-executable instruction may be any form of instruction, and the foregoing computer program may be any form of application, module, or plug-in.

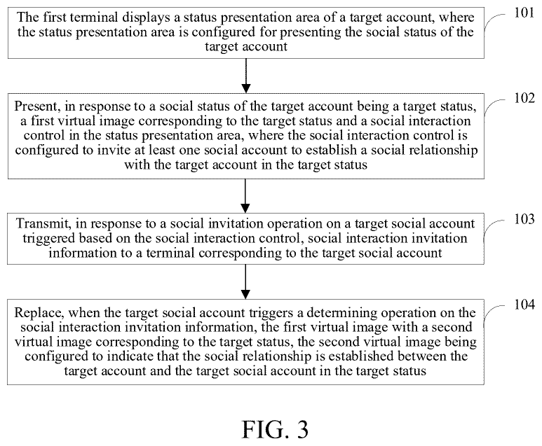

As described above, the social interaction method provided in embodiments of this application may be implemented by various types of electronic devices, for example, the method may be independently performed by the terminal in FIG. 1, or may be jointly performed by the terminal and the server 200 in FIG. 1. In the following, for example, only the terminal in FIG. 1 executes the social interaction method provided by the embodiments of this application. FIG. 3 is a schematic flowchart of a social interaction method according to an embodiment of this application. The method is applied to a social interaction invitation initiating terminal (first terminal for short below), and is described with reference to operations shown in FIG. 3.

Operation 101: The first terminal displays a status presentation area of a target account, where the status presentation area is configured for presenting the social status of the target account.

In one embodiment, a client having a social function, for example, a social client or an instant messaging client is placed on the first terminal. When a user corresponding to the target account opens the client on the first terminal to view a current social status of the target account, the status presentation area of the target account is displayed, to present the current social status of the target account and status description information corresponding to the current social status (that is, related information configured for describing the current social status of the target account) in the status presentation area. There are a plurality of forms of status description information. For example, the status description information may be a social status text description (that is, the current social status of the target account is described in a text form), may be a virtual image description (that is, the current social status of the target account is described in a virtual image form), or certainly may be a description manner in another form. A form of the status description information is not limited in this embodiment of this application.

The social status refers to a login state (for example, online, away, busy, or offline) of a login account (for example, a target account), a network connection state (for example, wireless login or mobile communication login), an online time length, a last activity time, or another state that can express a current mood, behavior, or expectation of a user (for example, listening to a song, messing around, or leaving me alone).

Operation 102: Present, in response to a social status of the target account being a target status, a first virtual image corresponding to the target status and a social interaction control in the status presentation area, where the social interaction control is configured to invite at least one social account to establish a social relationship with the target account in the target status.

In some embodiments, before the first terminal presents the first virtual image corresponding to the target status in the status presentation area, the social status of the target account may be set in the following manner: displaying a status setting control corresponding to the target account; displaying at least one candidate social status in response to a trigger operation on the status setting control; and setting, in response to a selection operation on the target status of the at least one candidate social status, the social status of the target account to the target status.

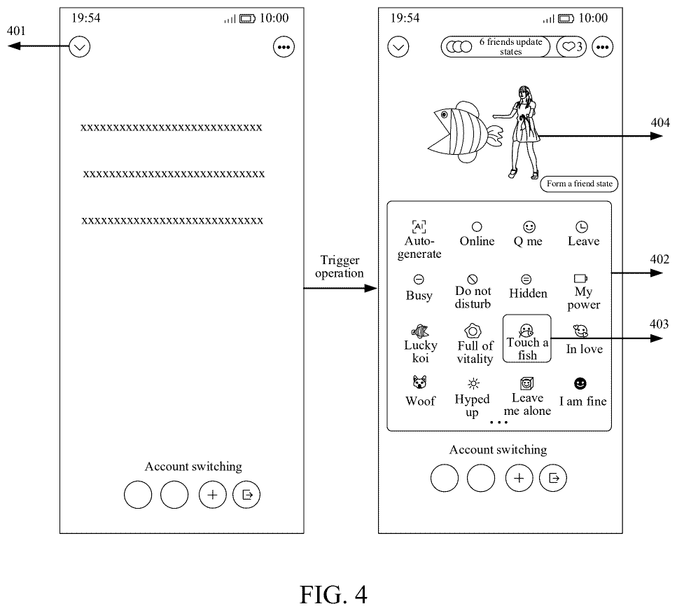

FIG. 4 is a schematic diagram of a social status setting interface according to the embodiments of this application. A status setting control 401 configured to set a social status of a target account is displayed in a status presentation area of the target account. In response to a trigger operation on the status setting control 401, a status setting interface 402 is displayed, and a plurality of candidate social statuses that are selectable are displayed in the status setting interface 402. In response to a selection operation on a target status (for example, mess around) 403 of the plurality of candidate social statuses, a current social status of the target account is set to the target status (that is, mess around) 403, and a first virtual image 404 corresponding to the target status (that is, mess around) is displayed. Accordingly, the current social status of the target account may be vividly transferred by using the first virtual image, thereby not only enriching social status transfer display styles, but also meeting increasingly diversified information obtaining requirements of the user, and improving the utilization of graphic processing resources.

In some embodiments, the first terminal may present the first virtual image corresponding to the target status in the status presentation area in the following manner: obtaining a status identifier of the target status, and a correspondence between different social status and different virtual images; and querying the correspondence based on the status identifier, using a found virtual image as the first virtual image corresponding to the target status, and presenting the first virtual image in the status presentation area.

In one embodiment, a social status and a virtual image (for example, a super show image, a costume, an accessory, an action, or a background) corresponding to the social status may be created by operation personnel. When creating a virtual image in a social status, the operation personnel may create one or more (two or more) virtual images for one social status, and establish a correspondence between social statuses and virtual images. For example, a social status 1 corresponds to a virtual image 1, and a social status 2 corresponds to a virtual image 2 and a virtual image 3. During establishment of an association, a correspondence between status identifiers of social statuses and character identifiers of corresponding virtual images may be established, and the established correspondence is stored for subsequent query to obtain a corresponding virtual image based on a social status that is set by a user. For example, when the current social status of the target account is the target status, the stored correspondence is queried according to the status identifier of the target status, to find an image identifier corresponding to the status identifier of the target status, and a corresponding first virtual object is obtained according to the found image identifier for presentation.

When the target status corresponds to a plurality of virtual images, a virtual image that conforms to the current status of the target account may be selected from the plurality of corresponding virtual images according to account data of the target account (for example, an account level, an account activity degree, and user data corresponding to the account (for example, gender, age, education experience, and interests and hobbies)), to improve a degree of adaptation between the presented virtual image corresponding to the target status and the target account, and improve pertinence of displaying of the virtual image.

In some embodiments, the first terminal may present the first virtual image corresponding to the target status in the status presentation area in the following manner: displaying a status image creation control corresponding to the target account; determining, in response to an information editing operation triggered based on the status image creation control, at least one of the following types of description information corresponding to the information editing operation: text, picture, and audio/video; and setting a social status of the target account to a target status in response to a determining operation on the description information, and presenting a first virtual image corresponding to the target status in the status presentation area, where the target status is determined according to the edited description information, and the first virtual image is generated based on the description information.

In one embodiment, the current social status (for example, the target status) of the user and the corresponding first virtual image may alternatively be created by the user through customization. For example, when the user triggers the status image creation control (configured to set a social status of the target account and a virtual image corresponding to the social status), the first terminal displays an information editing interface in response to a trigger operation on the status image creation control, and the user may edit at least one of description information of a text type, description information of a picture type, or description information of an audio/video type by using the information editing interface. When the type of the description information is the text type, the description information of the text type may be obtained by inputting text information through a text editing area, or may be obtained by performing text conversion on a voice file recorded through a voice recording control. The description information of the picture type and the description information of the audio/video type may be captured in real time by using a camera of the first terminal, or may be imported from locally stored pictures, and audio/videos, or may be imported after being obtained from the Internet.

The first terminal determines the target status of the target account according to the description information in response to a determining operation on the description information, and generates a corresponding first virtual image according to the description information. For example, the first terminal performs text recognition on the description information, to obtain a recognized text corresponding to the description information, and uses the recognized text as the target status of the target account, or extracts key information from the recognized text and uses the key information as the target status of the target account, or performs semantic understanding on the recognized text or key information and uses obtained semantic information as the target status of the target account; and then performs keyword extraction on the recognized text, to obtain at least one keyword of the recognized text, and invokes a virtual image model according to the keyword to perform image prediction processing, to obtain the first virtual image corresponding to the description information, where the virtual image model is obtained through training based on a keyword of a description information sample and a virtual image associated with the description information sample.

When text recognition is performed on the description information to obtain a recognized text, different types of description information correspond to different processing methods. For example, for description information of a text type, the description information may be directly used as a recognized text. Expression recognition is performed on an expression element when the description information of the text type includes the expression element, to obtain a recognized text configured for representing an intention or a sentiment transferred by the expression element. For example, such an expression element as [symbol] corresponds to a recognized text of rose, and expresses a love confession or love showing context. For description information of a picture type, visual feature extraction may be performed on the description information of the picture type, to obtain a visual feature of the description information of the picture type, semantic understanding is performed on the description information of the picture type, to obtain a semantic feature of the description information of the picture type, feature fusion is performed on the visual feature and the semantic feature, to obtain a multi-modal feature of the description information of the picture type, and text recognition is performed on the description information of the picture type based on the multi-modal feature, to obtain a recognized text of the description information of the picture type. For description information of an audio/video type, key frame extraction may be performed on the description information of the audio/video type, to obtain a key frame of the description information of the audio/video type, semantic understanding is performed on the key frame, to obtain a semantic feature of the description information of the audio/video type, and then text recognition is performed according to the semantic feature, to obtain a recognized text of the description information of the audio/video type.

After the recognized text is obtained, keyword extraction is performed on the recognized text, to obtain at least one keyword of the recognized text. Then, the keyword is input into the virtual image model for image prediction processing, and the first virtual image obtained through prediction is used as the virtual image corresponding to the description information. Before the virtual image model is applied, an initial virtual image model needs to be trained, and then the trained virtual image model is put into application, to predict a corresponding first virtual image by using an artificial intelligence technology with reference to description information edited by a user.

The virtual image model is obtained through training through a keyword corresponding to a description information sample and a virtual image associated (or marked) with the description information sample. For example, an initial virtual image model is invoked for prediction processing based on the keyword of the description information sample and the virtual image that is associated with the description information sample, to obtain a predicted virtual image. After the value of a loss function of the virtual image model is determined by using the predicted virtual image and the marked virtual image, whether the value of the loss function exceeds a preset threshold may be determined. When the value of the loss function exceeds the preset threshold, an error signal of the virtual image model is determined based on the loss function, the error signal is back-propagated in the virtual image model, and a model parameter of each layer is updated in a propagation process. A model structure of the virtual image model is not limited in this embodiment of this application. For example, the virtual image model may be a convolutional neural network or a deep neural network. The form of the loss function is not limited either. For example, the loss function may be a cross-entropy loss function or an L2 loss function.

The back-propagation is described herein. Training sample data is inputted into an input layer of a virtual image model, passes through a hidden layer, and finally reaches an output layer, and the result is outputted. This is a forward-propagation process of the virtual image model. Because there is an error between an output result of the virtual image model and an actual result, an error between the output result and an actual value is calculated, and the error is back-propagated from the output layer to the hidden layer until the error is propagated to the input layer. In a back-propagation process, a value of the model parameter is adjusted based on the error. That is, a loss function is constructed according to an error between an output result and an actual value, a partial derivative of the loss function for the model parameter is solved layer by layer, and a gradient of the loss function for a parameter of a model at each layer is generated. Because a direction of the gradient indicates a direction of error expansion, the gradient of the model parameter is inverted, and the inverted gradient and an original parameter of a model at each layer are added, and an obtained summation result is used as an updated parameter of a model at each layer, thereby reducing an error caused by the model parameter. The foregoing process is continuously iterated until convergence is achieved.

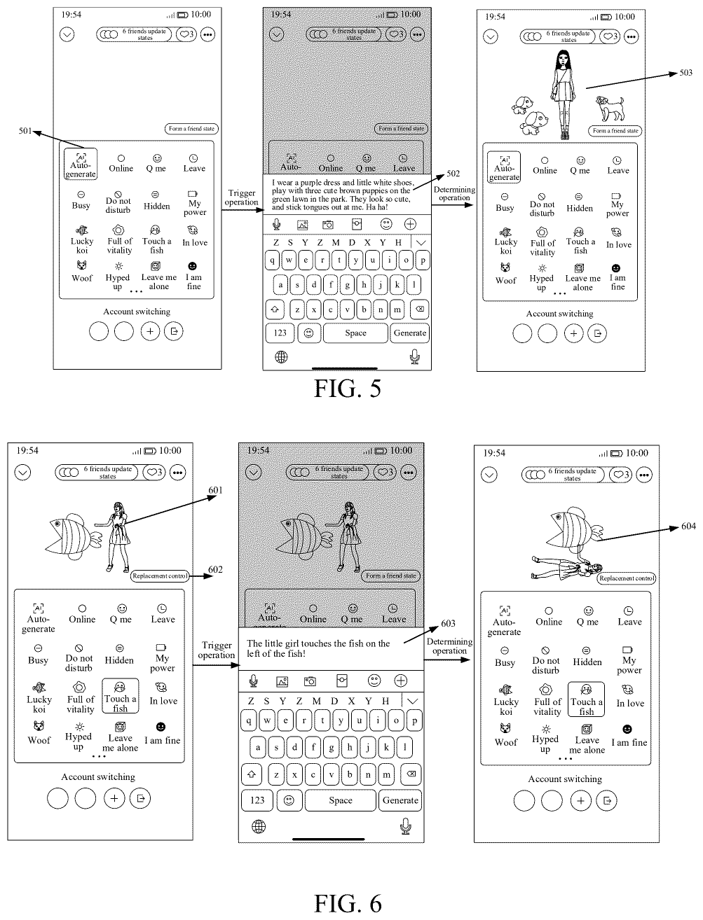

FIG. 5 is a schematic diagram of creating a virtual image according to an embodiment of this application. A status image creation control (for example, “auto-generate”) 501 corresponding to the target account is displayed. A status image editing area is displayed in response to a trigger operation on the status image creation control 501, and a text input box and a virtual keyboard are displayed in the status image editing area, where corresponding description information (for example, “I wear a purple dress and little white shoes, play with three cute brown puppies. They look so cute, and stick tongues out at me. Ha ha!”) 502 may be input in the text input box by using the virtual keyboard. The description information 502 is used as a current target status of the target account in response to a determining operation (for example, tapping a generation key) on the description information 502, a corresponding first virtual image is generated according to the description information in the foregoing manner, and the first virtual image 503 is presented in a status presentation area as a virtual image (for example, a background picture in which a little girl plays with three puppies) corresponding to the target status. Accordingly, a user may edit a social status through customization and generate a corresponding virtual image, that is, may generate a virtual image corresponding to a target status through customization in a social status presentation application, thereby increasing flexibility of generating a virtual image, enriching social status presentation styles, meeting increasingly diversified information obtaining requirements of the user, and improving the utilization of graphic processing resources.

In some embodiments, the first terminal may obtain the first virtual image corresponding to the target status in the following manner: performing, when a type of the description information is a picture type, special effect conversion processing on the description information of the picture type, to obtain a special effect picture of the description information of the picture type, and determining the special effect picture as the first virtual image corresponding to the target status, to present the first virtual image in the status presentation area.

The special effect picture may be considered as a picture obtained by adding a special effect element to description information (which is actually a picture) of a picture type (that is, the special effect picture includes original content of the description information and the special effect element). The special effect picture may alternatively be considered as a picture of a different style obtained by performing style conversion on description information (which is actually a picture) of an original picture type. For example, if description information is a life photograph (that is, a life photograph of the user, indicating a real image of the user) of the target account, a special effect picture of a different style (for example, a picture of an animation style, indicating a virtual image of the user) may be obtained by performing special effect conversion processing on the description information. When the special effect picture is used as the first virtual image, the first virtual image is a virtual image of an animation style that is obtained by performing special effect conversion processing on the description information (that is, a life photograph of the user, indicating a real image of the user). In this case, the first virtual image may be considered as a dynamic picture or a static picture of the animation style. Accordingly, the user may arbitrarily import a picture that the user wants to express as description information, and rapidly generate and present a virtual image of the animation style consistent with the picture according to the description information, thereby improving processing efficiency and also improving applicability of generating the virtual image.

In some embodiments, before the terminal presents the first virtual image corresponding to the target status in the status presentation area, the first virtual image may be further generated in the following manner: displaying at least one image label that is in an operable state, the image label being obtained by performing label recognition on the description information, and being configured for indicating an image characteristic of a corresponding virtual image; and obtaining, in response to a selection operation on a target image label, the first virtual image conforming to an image characteristic indicated by the target image label.

In one embodiment, when the first virtual image is generated according to the description information corresponding to the information editing operation triggered by the user, the terminal may display, in response to a determining operation on the description information in the status image editing area, one or more image labels that can be triggered and selected (that is, the label of the type is in an operable state), such as an image label 1 (a sweet type), an image label 2 (a Lolita type), an image label 3 (a hot girl type), an image label 4 (a long hair type), and an image label 5 (a dress type). These image labels are obtained by the terminal by performing label recognition on the description information edited by the user, for example, performing semantic understanding on the description information, to obtain semantic information transferred by the description information, and performing label classification processing according to the semantic information, to obtain image labels corresponding to the description information, where the image labels are configured for indicating image characteristics of virtual images generated based on the image labels, for example, the sweet type, the Lolita type, and the long hair type. The user may select one or more image labels from the image labels as a reference standard for generating the first virtual image. For example, when the user selects a target image label (for example, the foregoing image label 2) from the image labels, a first virtual image (that is, a virtual image of the hot girl type) conforming to the target image label (for example, the foregoing image label 2) is generated as a virtual image of the target account in the target status. Accordingly, the user may select a needed image label according to an actual requirement to generate a virtual image of a corresponding image characteristic, which can improve pertinence and appropriateness of generating a virtual image.

In some embodiments, the first terminal may present the first virtual image corresponding to the target status in the status presentation area in the following manner: presenting an initial virtual image corresponding to the target status and a replacement control configured to replace the initial virtual image in the status presentation area; determining, in response to an information update operation that is triggered based on the replacement control, description information of at least one of the following types corresponding to the information update operation: text, picture, and audio/video; and replacing, in response to a determining operation on the description information, the initial virtual image presented in the status presentation area with the first virtual image, the first virtual image being generated based on the description information.

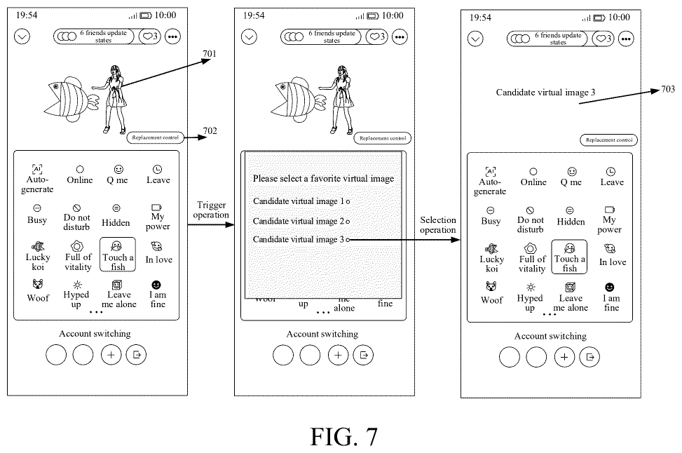

FIG. 6 is a schematic diagram of creating a virtual image according to an embodiment of this application. An initial virtual image (for example, a background picture in which a little girl touches a fish on the right of the fish) 601 corresponding to a current target status (for example, mess around) of a target account and a replacement control 602 are presented in a status presentation area of the target account. In response to a trigger operation on the replacement control 602, a virtual image replacement area is displayed, a text input box and a virtual keyboard are displayed in the virtual image replacement area, and corresponding description information (for example, “a little girl is lying down and messing around”) 603 may be input in the text input box by using the virtual keyboard. In response to a determining operation on the description information 603, the initial virtual image 601 presented in the status presentation area is replaced with a first virtual image (for example, a background picture in which a little girl is lying down and messing around) 604 generated according to the description information for presentation in the status presentation area. Accordingly, a virtual image corresponding to a target status may be replaced through customization in a social status presentation application, thereby increasing flexibility of setting a virtual image, and enriching social status presentation styles.

When the initial virtual image is replaced based on the replacement control, a method for generating the first virtual image according to the description information is the same as the foregoing method for generating, in response to an information editing operation triggered based on a status image creation control, a first virtual image according to description information, and details are not described herein again.

In some embodiments, the first terminal may present the first virtual image corresponding to the target status in the status presentation area in the following manner: presenting an initial virtual image corresponding to the target status and a replacement control configured to replace the initial virtual image in the status presentation area; displaying, in response to a trigger operation on the replacement control, at least one candidate virtual image matching the target status, the at least one candidate virtual image including the first virtual image; and replacing, in response to a selection operation on the first virtual image, the initial virtual image presented in the status presentation area with the first virtual image.

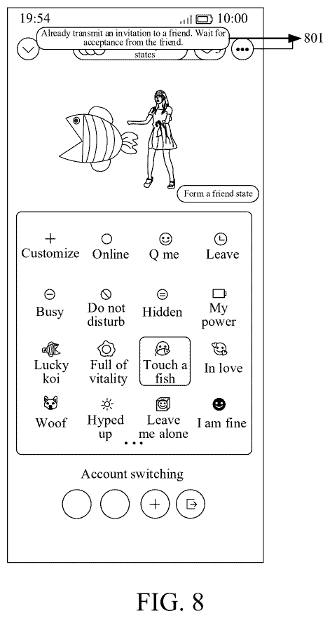

In one embodiment, a same social status may correspond to a plurality of virtual images (that is, for a same social status, there are a plurality of virtual images matching the social status, and matching means that meanings or intentions transferred by the social status are consistent with meanings or intentions transferred by the virtual images). When there are a plurality of virtual images corresponding to a target status, a currently displayed initial virtual image corresponding to the target status may be replaced by using the replacement control. FIG. 7 is a schematic diagram of creating a virtual image according to an embodiment of this application. An initial virtual image 701 corresponding to a current target status of a target account and a replacement control 702 are presented in a status presentation area of the target account. In response to a trigger operation on the replacement control 702, a plurality of candidate virtual images (each of which matches the target status) that are selectable, such as a candidate virtual image 1, a candidate virtual image 2, and a candidate virtual image 3 are displayed. In response to a selection operation on the candidate virtual image 3 (that is, the first virtual image), the initial virtual image 701 presented in the status presentation area is replaced with the candidate virtual image 3 (that is, the first virtual image 703). Accordingly, a user may quickly replace a virtual image corresponding to a target status, thereby improving efficiency of replacing a virtual image, and enriching social status presentation styles.

Each replaced virtual image is still associated with the replacement control, and the replaced virtual image may be replaced again by using the replacement control. The rest can be deduced by analogy, until a satisfactory first virtual image is obtained through replacement.

In some embodiments, the first terminal may present a social interaction control in the status presentation area in the following manner: presenting, when at least two types of social relationships are provided social interaction controls corresponding to the social relationships of the types in the status presentation area, a one-to-one correspondence existing between the social interaction controls and the types of the social relationships.

Each social relationship may correspond to one social interaction control. For example, a social relationship 1 corresponds to a social interaction control 1, and a social relationship 2 corresponds to a social interaction control 2. By using a social interaction control corresponding to the target status, at least one social account may be invited to establish a social relationship with the target account in the target status.

The social relationship is configured for representing an association between social accounts, and may be, for example, a relationship such as lover, lady bro, bro, or all-weather friends. In one embodiment, a social relationship between the target account and another social account may be determined according to the frequency of sessions between the target account and another social account, or remark information, classification information, or the like of the target account for the another social account.

Operation 103: Transmit, in response to a social invitation operation on a target social account triggered based on the social interaction control, social interaction invitation information to a terminal corresponding to the target social account.

In some embodiments, when at least two types of social relationships are provided, social interaction controls corresponding to the at least two types of social relationships are presented in the status presentation area; and before transmitting the social interaction invitation information to the terminal (that is, the second terminal) corresponding to the target social account, the first terminal may receive the social invitation operation in the following manner: displaying, in response to a trigger operation on the social interaction control, at least one candidate social account and at least one type of social relationship that are selectable; determining, in response to an account selection operation, a target social account that the account selection operation instructs to select, and determining, in response to a relationship selection operation, a social relationship of a target type that the relationship selection operation instructs to select; and receiving, in response to a determining operation on the target social account and the social relationship of the target type, a social invitation operation on the target social account, the social invitation operation being configured for inviting the target social account to establish the social relationship of the target type with the target account in the target status.

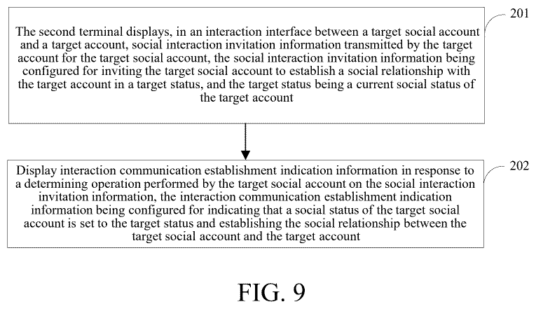

When there are at least two types of social relationships, and all the types of social relationships correspond to one social interaction control, after setting the social status of the target account to the target status, the first terminal displays, in response to a trigger operation on the social interaction control, at least one candidate social account and at least one type of social relationship that are selectable. When the user selects a target social account and a social relationship of a target type (for example, lady bro) from the at least one candidate social account and the at least one type of social relationship and triggers an OK key, the first terminal receives a social invitation operation on the target social account, and transmits social interaction invitation information to the second terminal corresponding to the target social account, to invite the target social account to establish the social relationship of the target type (for example, lady bro) with the target account in the target status, that is, invite the target social account to set a social status of the target social account to the target status, and establish the social relationship of the target type (for example, lady bro) with the target account in the target status; and after transmitting the social interaction invitation information, presents feedback prompt information corresponding to the social interaction invitation information in the status presentation area, to prompt to wait for feedback from the target social account on the social interaction invitation information, as shown in FIG. 8. FIG. 8 is a schematic diagram of displaying feedback prompt information according to an embodiment of this application, where such feedback prompt information 801 as “Already transmit an invitation to a friend. Wait for acceptance from the friend” is shown.

In some embodiments, when there are at least two types of social relationships, and each social relationship may correspond to one social interaction control, before transmitting the social interaction invitation information to the terminal corresponding to the target social account, the first terminal may receive the social invitation operation in the following manner: displaying, in response to a trigger operation on a social interaction control corresponding to a social relationship of a target type, at least one candidate social account that is selectable; determining, in response to an account selection operation, a target social account that the account selection operation instructs to select; and receiving, in response to a determining operation on the target social account, a social invitation operation on the target social account, the social invitation operation being configured for inviting the target social account to establish the social relationship of the target type with the target account in the target status.

When there are at least two types of social relationships, and each social relationship may correspond to one social interaction control, for example, such a social relationship as “lover” corresponds to a social interaction control 1 and such a social relationship as “lady bro” corresponds to a social interaction control 2, the first terminal displays, in response to a trigger operation on a social interaction control (for example, the social interaction control 1) corresponding to a social relationship of a target type, at least one candidate social account that is selectable. When the user selects a target social account from the at least one candidate social account and triggers an OK key, the first terminal receives a social invitation operation on the target social account, and transmits social interaction invitation information to the second terminal corresponding to the target social account, to invite the target social account to establish the social relationship of the target type (that is, lover) with the target account in the target status, that is, invite the target social account to set a social status of the target social account to the target status, and establish the social relationship of the target type (that is, lover) with the target account in the target status; and after transmitting the social interaction invitation information, presents feedback prompt information corresponding to the social interaction invitation information in the status presentation area, to prompt to wait for feedback from the target social account on the social interaction invitation information. for example, “Already transmit an invitation to a friend. Wait for acceptance from the friend”.

In one embodiment, social interaction controls may alternatively be different according to different target quantities of social accounts required to be associated by the social relationship. For example, such a social relationship as “lover” or “couple” in which a target quantity of social accounts required to be associated is 2 corresponds to the social interaction control 1, and such a social relationship as “lady bro” or “all-weather friend” in which a target quantity of social accounts required to be associated may be greater than 2 corresponds to the social interaction control 2. When one social interaction control corresponds to a plurality of (two or more) social relationships, a social relationship of a target type to be established and a quantity of target social accounts to be selected may be selected from the social relationships and the target quantities based on the social interaction control.

In some embodiments, selection prompt information is displayed when an account quantity of target social accounts that the account selection operation instructs to select does not meet a target quantity corresponding to the social relationship of the target type, the selection prompt information being configured for prompting to reselect another quantity of target social accounts, and the another quantity being less than the previously selected account quantity. For example, when a social relationship of a target type is a “lover” or “couple” relationship, a target quantity corresponding to the social relationship of the target type is 2, that is, if the social relationship of the target type selected by the user is the “lover” or “couple” relationship, the user can select only one target social account (that is, a target quantity associated with the social relationship of the target type is 1). When the user selects two or more target social accounts (that is, the selected account quantity is 2 or greater than 2, both being greater than the associated target quantity) from the target social accounts, an error prompt is transmitted, to prompt the user to reselect another quantity (that is, 1) of target social accounts. If the account quantity of target social accounts selected by the user from the target social accounts reaches the target quantity of social accounts required to be associated by the social relationship, another unselected candidate social account may be automatically controlled to be in a non-selectable state. For example, if a social relationship of a target type selected by the user is the “lover” or “couple” relationship, and a target quantity associated with the social relationship of the target type is 1, another unselected candidate social account is controlled to be in a non-selectable state after 1 target social account is selected from the target social accounts, to avoid incorrect selection.

Operation 104: Replace, when the target social account triggers a determining operation on the social interaction invitation information, the first virtual image with a second virtual image corresponding to the target status, the second virtual image being configured to indicate that the social relationship is established between the target account and the target social account in the target status.

In one embodiment, the social interaction invitation information may be associated with an interaction entrance configured for accepting or rejecting an invitation. For example, when the social interaction invitation information is presented in the form of an information card, the interaction entrance configured for accepting or rejecting an invitation, such as an accept key or a reject key may be further presented on the information card. When the target social account agrees to the invitation, the accept key may be triggered to trigger a determining operation on the social interaction invitation information. In this case, a social status of the target social account may be set to a target status consistent with that of the target account, and a corresponding social relationship between the target account and the target social account is established. For example, when the social interaction control is configured to invite the target social account to establish a lover relationship with the target account in the target status, the lover relationship between the target account and the target social account is established. In addition, the first terminal on the target account side and the second terminal on the target social account side update virtual images configured for representing that the corresponding social relationship is established in the target status, for example, replace the first virtual image presented in the status presentation area of the target account with the second virtual image, and present the second virtual image in the status presentation area of the target social account.

The second virtual image may be created by operation personnel, or may be created by the user through customization. A method for creating the second virtual image is the same as the method for creating the first virtual image, and details are not described herein again.

In the foregoing manner, another social account may be invited, by using a social interaction control, to establish a social relationship with the target account in the target status, and when the target social account receives a social interaction invitation of the target account, the first virtual image of the target account is replaced with the second virtual image. Because the second virtual image is configured to indicate that a corresponding social relationship is established between the target account and the target social account in the target status, it can be known that when the target social account receives the social interaction invitation of the target account, the social status of the target social account may be automatically set to the target status the same as that of the target account, and the social relationship established between the target social account and the target account may be presented by using the second virtual image, thereby increasing interactivity based on the social status. In addition, because the first virtual image and the second virtual image both correspond to the target status, virtual image elements are added to a social status presentation application, thereby enriching social status presentation styles, and improving utilization of graphic processing resources.

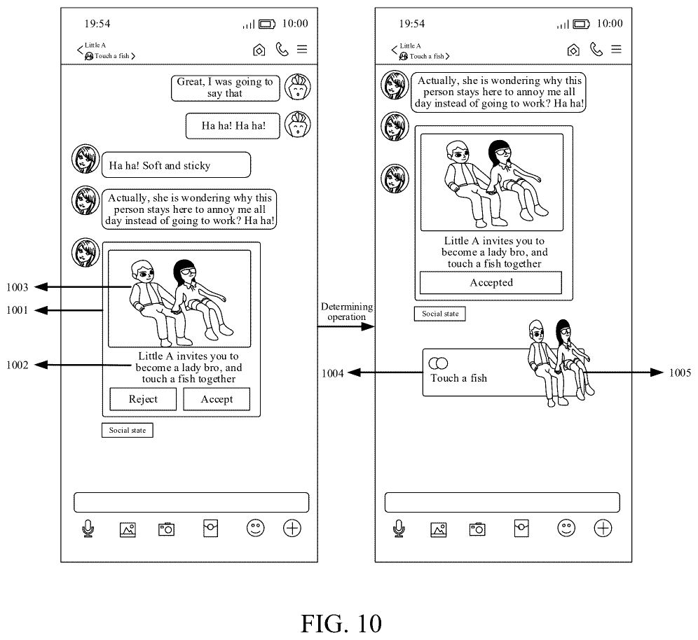

FIG. 9 is a schematic flowchart of a social interaction method according to an embodiment of this application. The method is applied to a social interaction invitation receiving terminal (second terminal for short below), and is described with reference to operations shown in FIG. 9.

Operation 201: The second terminal displays, in an interaction interface between a target social account and a target account, social interaction invitation information transmitted by the target account for the target social account, the social interaction invitation information being configured for inviting the target social account to establish a social relationship with the target account in a target status, and the target status being a current social status of the target account.

After A first terminal (that is, an initiating terminal of the social interaction invitation) corresponding to the target account in the target status transmits the social interaction invitation information to the second terminal corresponding to the target social account, the interaction interface between the target social account and the target account is displayed in the second terminal corresponding to the target social account, and the social interaction invitation information is displayed in the interaction interface, to invite the target social account to establish a corresponding social relationship with the target account.

Assuming that the target status of the target account (for example, Little A) is “mess around”, when social interaction invitation information transmitted by the first terminal corresponding to the target account (that is, Little A) is configured for inviting the target social account (for example, Little B) to establish a lady bro relationship with the target account (that is, Little A) in such a social status (that is, the target status) as “mess around”, social interaction invitation information displayed on the second terminal corresponding to the target social account (that is, Little B) may be represented as “Little A invites you to become a lady bro, and mess around together”.

Operation 202: Display interaction communication establishment indication information in response to a determining operation performed by the target social account on the social interaction invitation information, the interaction communication establishment indication information being configured for indicating that a social status of the target social account is set to the target status and establishing the social relationship between the target social account and the target account.

The social interaction invitation information may be associated with an interaction entrance configured for accepting or rejecting an invitation, such as an accept key or a reject key. When the target social account agrees to the invitation, the accept key may be triggered to trigger a determining operation on the social interaction invitation information. The terminal corresponding to the target social account displays the interaction communication establishment indication information in response to the determining operation, to indicate that the social status of the target social account is set to the target status consistent with that of the target account. Continuing the foregoing description, when the target social account (that is, Little B) agrees to the invitation of the target account (that is, Little A), the social status of the target social account (that is, Little B) is set to “mess around”, and a lady bro relationship is established between the target social account (that is, Little B) and the target account (that is, Little A), that is, Little A and Little B are in the lady bro relationship, and the two persons are in the social status of “mess around” together.

In some embodiments, the second terminal may display, in the following manner in an interaction interface between a target social account and a target account, social interaction invitation information transmitted by the target account for the target social account: displaying an information card in the interaction interface between the target social account and the target account, and displaying, on the information card, the social interaction invitation information transmitted by the target account for the target social account, and a third virtual image, the third virtual image being configured to preview the social relationship established between the target social account and the target account. Correspondingly, the second terminal may further display the interaction communication establishment indication information in the following manner: displaying a status card configured for indicating that the target social account is in the target status, and displaying the third virtual image on the status card, to use the status card and the third virtual image as the interaction communication establishment indication information.

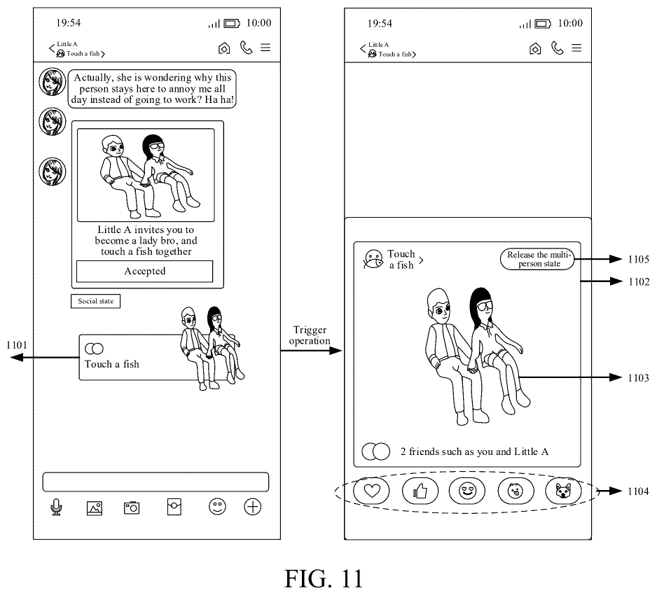

FIG. 10 is a schematic diagram of displaying social interaction invitation information according to an embodiment of this application. Social interaction invitation information may be presented in the form of an information card. Social interaction invitation information (for example, “Little A invites you to become a lady bro, and mess around together”) 1002 is presented on an information card 1001, and a third virtual image 1003 is displayed on the information card 1001 as a background picture. The third virtual image 1003 includes 2 virtual characters (a quantity of the virtual characters is the same as a quantity of friends forming a double-person state\us), and is configured for previewing a social relationship established between a target social account and a target account after the target social account accepts a social interaction invitation. In addition, the interaction entrance configured for accepting or rejecting an invitation, such as an accept key or a reject key may be further presented on the information card. When the target social account agrees to the invitation, the accept key may be triggered to trigger a determining operation on the social interaction invitation information. A second terminal corresponding to the target social account displays a status card 1004 in response to the determining operation, and displays a third virtual image 1005 on the status card 1004 as interaction communication establishment indication information, to indicate that the target social account accepts the social interaction invitation. In this case, a social status of the target social account is set to a target status (for example, “mess around”) consistent with that of the target account, and a corresponding social relationship (that is, a lady bro relationship) between the target account and the target social account is established.

In some embodiments, the second terminal displays a details interface of the status card in response to a trigger operation on the status card, and displays an interaction control in the details interface, the interaction control being configured to interact with the third virtual image displayed on the status card.

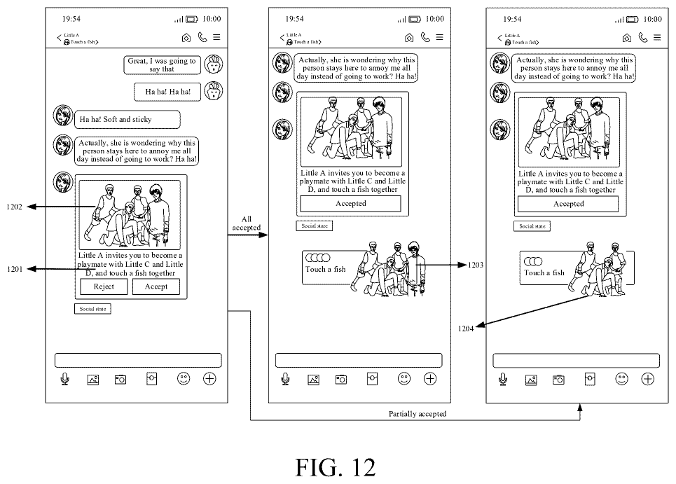

FIG. 11 is a schematic diagram of social interaction according to an embodiment of this application. In response to a trigger operation on a status card 1101, a details interface 1102 of the status card is displayed, and a target status (for example, “mess around”) of a target social account and a target account, a third virtual image 1103 for representing that a lady bro relationship is established between the target social account and the target account, and an interaction control 1104 are displayed in the details interface 1102. By using the interaction control 1104, interaction, for example, by transmitting an expression element, with the third virtual image 1103 displayed on the status card may be performed. In addition, a release control 1105 for releasing a social relationship is further displayed, and a social relationship established between a target social account and a target account may be released (for example, a lady bro relationship is released) by using the release control 1105. Accordingly, in a social status presentation application, social status presentation styles and interaction forms for interaction based on a social status are enriched, thereby improving the utilization of graphic processing resources.

In some embodiments, before displaying the interaction communication establishment indication information, the second terminal on the target social account side displays, in response to a status viewing operation on the target social account, a fourth virtual image corresponding to a current status of the target social account in a status presentation area of the target social account; and correspondingly replaces, after the interaction communication establishment indication information is displayed, the fourth virtual image with the third virtual image in the status presentation area of the target social account.

Before accepting the social interaction invitation information transmitted by the target account, the second terminal on the target social account side presents, in response to a status viewing operation on the target social account, a fourth virtual image corresponding to a current status of the target social account in a status presentation area of the target social account. If the target social account is in a status of “listen to a song”, the fourth virtual image is a virtual image corresponding to the status of “listen to a song”. When the social interaction invitation information is that the target account in the target status of “mess around” invites the target social account to form a lady bro status, after the target social account accepts the social interaction invitation, the social status of the target social account is converted from “listen to a song” to “mess around”, and a lady bro status is established between the target social account and the target account. Therefore, the fourth virtual image (corresponding to the social status of “listen to a song”) is replaced with the third virtual image corresponding to the social status of “mess around” and corresponding to the social relationship of “lady bro relationship” in the status presentation area of the target social account.

In some embodiments, when the social interaction invitation information is further configured for inviting another social account to establish a social relationship with the target account in the target status, the third virtual image is configured to preview the social relationship established between the target social account, the another social account, and the target account; and the second terminal on the target social account side may display the interaction communication establishment indication information in the following manner: displaying a fifth virtual image on the status card when the another social account triggers a reject operation on the social interaction invitation information, the fifth virtual image being different from the third virtual image, and the fifth virtual image is configured to indicate that the social relationship is established between the target social account and the target account.

When the social interaction invitation information is that the target account invites the target social account and another social account (one or more) to establish a corresponding social relationship in the target status, the third virtual image displayed on the information card is a virtual image corresponding to the target account, the target social account, and the another social account. When the third virtual image includes a plurality of virtual characters, the quantity of the virtual characters is an account quantity sum of the target account, the target social account, and the another social account, and the fifth virtual image displayed on the status card is a virtual image corresponding to social accounts accepting a social interaction invitation. When the fifth virtual image includes a plurality of virtual characters, the quantity of the virtual characters is an account quantity sum of the target account and the social accounts accepting the social interaction invitation.

For example, the third virtual image is still displayed on the status card when another social account triggers an accept operation on the social interaction invitation information. In this case, the third virtual image is configured for indicating that a social relationship is established between the target social account, the target account, and another social account. displaying a fifth virtual image on the status card when the another social account triggers a reject operation on the social interaction invitation information, the fifth virtual image being different from the third virtual image, and the fifth virtual image is configured to indicate that the social relationship is established between the target social account and the target account.

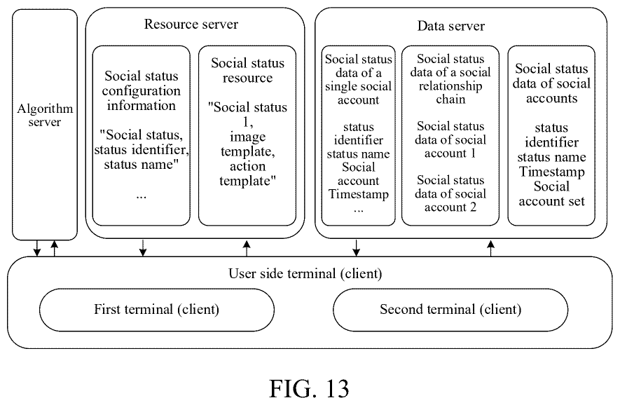

FIG. 12 is a schematic diagram of an interaction communication establishment indication according to an embodiment of this application. Using an example in which a virtual image includes a plurality of virtual characters, assuming that a target status of a target account (for example, Little A) is “mess around”, when social interaction invitation information transmitted by a first terminal corresponding to the target account (that is, Little A) is configured for inviting a target social account (for example, Little B) and two other social accounts (for example, Little C and Little D) to establish a playmate relationship with the target account (that is, Little A) in such a social status as “mess around”, social interaction invitation information 1201 displayed on a second terminal corresponding to the target social account may be represented as “Little A invites you to become a playmate with Little C and Little D, and mess around together”. In this case, a third virtual image 1202 displayed on an information card may include four virtual characters (that is, the quantity of virtual characters is a sum of accounts participating in social interaction, that is, a total of four objects Little A, Little B, Little C, and Little D participate in social interaction). If each of the target social account (that is, Little B) and the other social accounts (that is, Little C and Little D) accepts a social interaction invitation, a virtual image 1203 that is displayed on a status card and the third virtual image 1202 are consistent, and each include four virtual characters. If the target social account (that is, Little B) and another social account (that is, Little C) accept the social interaction invitation, while another social account (that is, Little D) rejects the social interaction invitation, a fifth virtual image 1204 displayed on a status card includes three virtual characters, which is different from the third virtual image 1202. Accordingly, an acceptance situation of the social interaction invitation may be learned according to virtual images on a status card.

In the foregoing manner, another social account is invited by the target account, by using a social interaction control, to establish a social relationship with the target account in the target status, and when the target social account receives a social interaction invitation of the target account, a social status of the target social account may be automatically set to a target status the same as that of the target account, the first virtual image of the target account in the target status is replaced with the second virtual image, and the corresponding virtual image is presented in the status presentation area of the target social account. Accordingly, the social relationship established between the target social account and the target account may be presented by using a virtual image, thereby increasing interactivity based on the social status. In addition, because each presented virtual image corresponds to the target status, virtual image elements are added to a social status presentation application, thereby enriching social status presentation styles, and improving utilization of graphic processing resources.

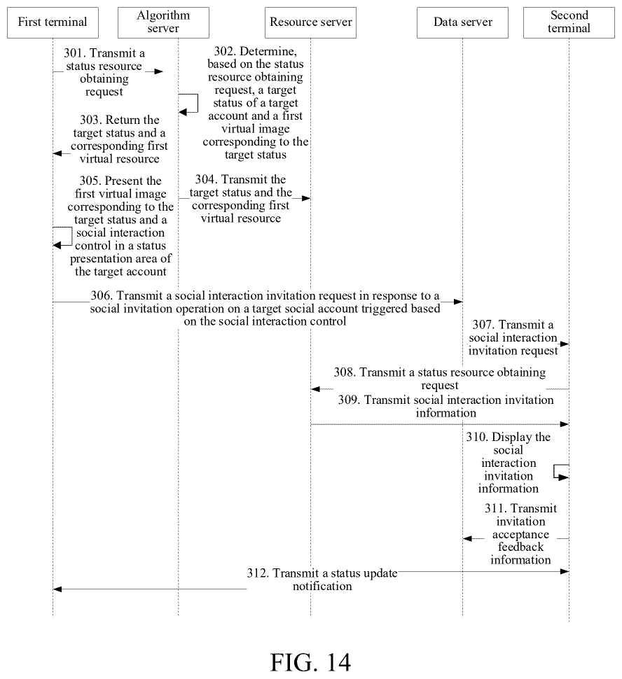

The following describes application of this embodiment of this application in an actual application scenario. FIG. 13 is a schematic diagram of an architecture of a social interaction system according to an embodiment of this application. The architecture includes a user side terminal, an algorithm server, a resource server, and a data server. The user side terminal includes a first terminal (an initiating terminal of a social interaction invitation) and a second terminal (a receiving terminal of a social interaction invitation). There may be a plurality of first terminals and a plurality of second terminals. A client is placed on each terminal. Each social account corresponds to one terminal. Next, the description is made using an example in which a terminal on a target account side is the first terminal and a terminal on a target social account side is the second terminal.

The algorithm server is configured to intelligently create, when creating a virtual image corresponding to a social status, a corresponding virtual image (a social status resource) according to description information provided by the user side terminal, return the generated virtual image to the user side terminal for presentation, and transmit the generated virtual image to the resource server for storage.

The resource server is configured to store social status configuration information and a social status resource. The social status configuration information is a configuration file, includes a virtual image corresponding to a social status created by the algorithm server and a virtual image corresponding to a social status created by operation and maintenance personnel, is usually maintained by operation personnel, and is configured for controlling whether a terminal presents a social status, which social statuses are presented, and the like. The social status resource is configured for storing a virtual image resource corresponding to each social status, for example, a virtual image 1 corresponding to a social status 1 and a virtual image 2 corresponding to a social status 2. The virtual image resource may include an image template (a virtual image of a user) and an action template (an action corresponding to the virtual image).

The data server is configured to store social status data of a single social account (for example, an account identifier, a social status identifier, and a social status name of a social account 1), social status data of a social relationship chain (for example, social status data of the social account 1 and social status data of a social account 2), and social status data of a plurality of social accounts between which a target social relationship is established (for example, a relationship identifier, a social status identifier, a social status name, and a social account set of the target social relationship).

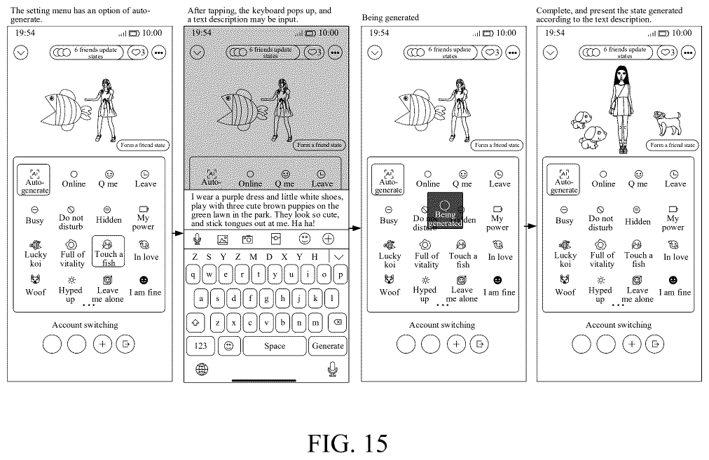

FIG. 14 is a schematic diagram of a method for creating a virtual image according to an embodiment of this application. The method includes:

Operation 301: A first terminal transmits a status resource obtaining request to an algorithm server.

In one embodiment, a user may select and set a current target status from social statuses created by operation and maintenance personnel, and a virtual image resource corresponding to the target status. Certainly, the user may further customize a current social status and a virtual image corresponding to the social status. Description is made below using an example in which the social status and the virtual image are set through customization.

A status image creation control configured to create a social status and a corresponding virtual image is displayed in a status presentation area of a target account. The first terminal displays a status image editing area in response to a trigger operation on the status image creation control, and displays a text input box and a virtual keyboard in the status image editing area, where corresponding description information may be input in the text input box by using the virtual keyboard; and transmits, in response to a determining operation on the description information, a status resource obtaining request carrying the description information to the algorithm server.

Operation 302: The algorithm server determines, based on the status resource obtaining request, a target status of a target account and a first virtual image corresponding to the target status.

When generating the target status and the first virtual image according to description information, the algorithm server may first perform text recognition on the description information, to obtain a recognized text corresponding to the description information, and use the recognized text as a current status of the target account; then perform keyword extraction on the recognized text, to obtain at least one keyword corresponding to the recognized text, and finally invoke a virtual image model according to the keyword to perform image prediction processing, to obtain the first virtual image corresponding to the description information.

The virtual image model is obtained through training based on a keyword corresponding to a description information sample and a virtual image associated with the description information sample. The virtual image model may include an image template and an action template. The image template is invoked according to a keyword configured for generating a virtual image to generate a corresponding virtual image (for example, a virtual character with long hair and a dress is generated according to keywords of types such as long hair and dress), the action template is invoked according to a keyword configured for generating an action to generate a corresponding action (for example, an action of game playing or fitness is generated according to a keyword of a type such as game playing or fitness), and the virtual image and the action that are generated are superimposed to generate a corresponding first virtual image.

Operation 303: The algorithm server returns the target status and the first virtual image corresponding to the target status to the first terminal.

Operation 304: The algorithm server transmits the target status and the first virtual image corresponding to the target status to a resource server for storage.

In one embodiment, after receiving the target status and the first virtual image corresponding to the target status, the first terminal may determine whether to apply the target status and the first virtual image. If the first terminal does not apply the target status and the first virtual image, the first terminal may transmit a discard request to the resource server, so that the resource server deletes the target status and the first virtual image based on the discard request, to reduce storage pressure. If the first terminal applies the target status and the first virtual image, the first terminal does not need to transmit the discard request to the resource server.

Operation 305: The first terminal presents the first virtual image corresponding to the target status and a social interaction control in a status presentation area of the target account.

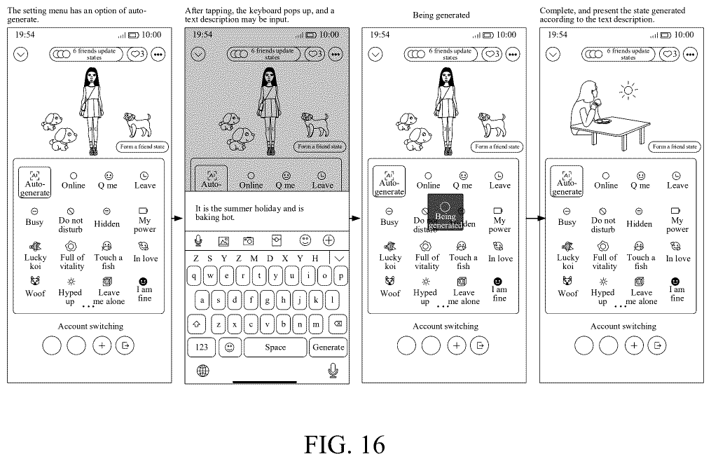

For example, FIG. 15 to FIG. 17 are schematic diagrams of creating a virtual image according to an embodiment of this application. In FIG. 15, when a target account taps an “auto-generate” key (that is, the foregoing status image creation control), and corresponding description information that may be input in a text input box by using a virtual keyboard is: “I wear a purple dress and little white shoes, play with three cute brown puppies. They look so cute, and stick tongues out at me. Ha ha!”), the information is used as a current social status (that is, target status) of the target account in response to a determining operation (for example, tapping a generation key) on the description information, and a first virtual image (for example, a background picture in which a little girl plays with three puppies) is presented according to the description information.

In FIG. 16, in a case that a current target status of a target account is “play with three puppies” and corresponds to an initial virtual image (for example, a background picture in which a little girl plays with three puppies), when the target account taps an “auto-generate” key (that is, the foregoing status image creation control), and such description information as “It is the summer holiday and is baking hot” may be input in a text input box by using a virtual keyboard, the description information is used as a current target status (that is, the status of “play with three puppies” replaced with “It is the summer holiday and is baking hot”) of the target account in response to a determining operation (for example, tapping a generation key) on the description information, and the presented initial virtual image is switched to present a first virtual image (for example, a background picture in which a little girl is sunbathing) generated according to the description information.

In FIG. 17, in a case that a current target status of a target account is “mess around” and corresponds to an initial virtual image (for example, a background picture in which a boy and a girl are messing around), when the target account taps an “auto-generate” key (that is, the foregoing status image creation control), and such description information as “The weather is very good, my marriage partner is incarnated as a big white bear, we sit on a picnic mat with brown markings and play a game together, and a puppy sits aside to watch us playing the game” may be input in a text input box by using a virtual keyboard, key information (for example, two persons are sitting on a picnic mat together to play a game, and a puppy is watching us playing the game) is extracted from the description information as a current target status of the target account (that is, “mess around” is replaced with “play a game”) in response to a determining operation (for example, tapping a generation key) on the description information, and the presented initial virtual image is switched to present a first virtual image (for example, a background picture in which two persons are sitting on a picnic mat together to play a game, and a puppy is watching us playing the game) generated according to the key information in the description information.

The social interaction control (for example, “forming a friend status” in FIG. 15 to FIG. 17) is configured to invite at least one social account to establish a social relationship with the target account in the target status.

Operation 306: The first terminal transmits a social interaction invitation request to a data server in response to a social invitation operation on a target social account triggered based on the social interaction control.

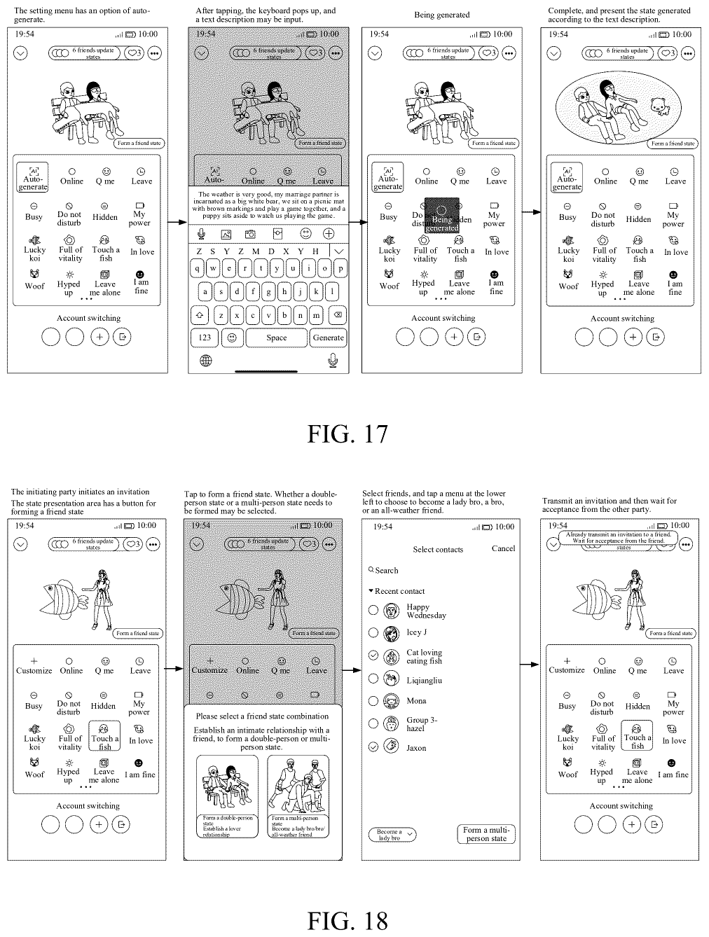

For example, FIG. 18 is a schematic diagram of social interaction according to an embodiment of this application. A first terminal displays, in response to a trigger operation on a social interaction control (for example, forming a friend status), at least one candidate social relationship that is selectable, for example, forming a double-person status (configured for forming a lover relationship) or forming a multi-person status (configured for forming a relationship such as lady bro/bro/all-weather friend). When the user chooses to form the multi-person status, the terminal displays, in response to the selection operation, at least one candidate social account and at least one type of social relationship (for example, lady bro/bro/all-weather friend) that are selectable, may select a target social account and a social relationship of a target type (for example, lady bro) from the at least one candidate social account and the at least one type of social relationship, and receives a social invitation operation on the target social account in response to a determining operation on the target social account and the social relationship of the target type, where the social invitation operation is configured for inviting the target social account to establish the social relationship of the target type (for example, a lady bro relationship) with the target account in the target status.

When the user chooses to form the double-person status, the terminal displays, in response to the selection operation, at least one candidate social account that is selectable, receives, in response to a determining operation on the target social account, a social invitation operation on the target social account, and transmits a social interaction invitation request to the data server, where the social interaction invitation request is configured for inviting the target social account to form the social relationship of the target type (that is, a lover relationship) with the target account in the target status.

Operation 307: The data server transmits the social interaction invitation request to a second terminal corresponding to the target social account.

After the data server transmits the social interaction invitation request to the second terminal corresponding to the target social account, corresponding feedback prompt information is presented in a status presentation area in the first terminal, to prompt to wait for feedback from the target social account on the social interaction invitation request, for example, such feedback prompt information as “Already transmit an invitation to a friend. Wait for acceptance from the friend” shown in FIG. 18.

Operation 308: The second terminal transmits the status resource obtaining request to the resource server.

Operation 309: The resource server determines a corresponding status resource based on the status resource obtaining request, assembles social interaction invitation information according to the status resource, and returns the social interaction invitation information to the second terminal.

The social interaction invitation request carries a status identifier of the target status and a relationship identifier of the social relationship of the target type. Similarly, the status resource obtaining request carries the status identifier of the target status and the relationship identifier of the social relationship of the target type. The resource server determines the corresponding status resource based on the status resource obtaining request, for example, obtains the corresponding target status based on the status identifier carried in the status resource obtaining request, obtains social status data of a corresponding social relationship chain according to the relationship identifier, and assembles corresponding social interaction invitation information according to the target status and the social status data of the social relationship chain.

Operation 310: The second terminal displays the social interaction invitation information.

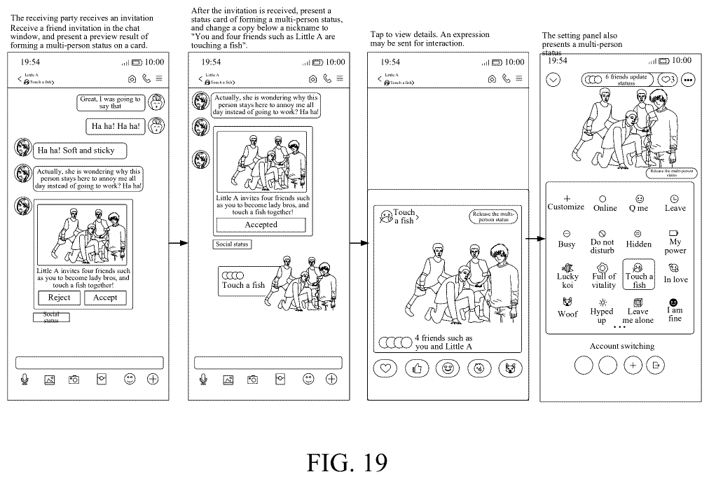

The social interaction invitation information may be presented in the form of an information card. Referring to FIG. 19, FIG. 19 is a schematic diagram of social interaction according to an embodiment of this application. Assuming that a target status of a target account (for example, Little A) is “messing around”, when social interaction invitation information transmitted by a first terminal corresponding to the target account (that is, Little A) is configured for inviting a target social account (for example, Little B) and other social accounts (for example, Little C and Little D) to establish a “lady bro relationship” with the target account (that is, Little A) in such a social status as “messing around”, an information card is displayed in second terminals corresponding to the target social account (that is, Little B) and the other social accounts (for example, Little C and Little D), social interaction invitation information such as “Little A invites 3 friends including you to form lady bros and mess around together” is displayed in the information card, and a second virtual image is displayed on the information card as a background picture. The second virtual image includes four virtual characters (a quantity of the virtual characters is the same as a quantity of friends forming a multi-person status, that is, a total of four friends including Little A, Little B, Little C, and Little D), and is configured for previewing a social relationship established between the target social account, the other social accounts, and the target account.

Operation 311: The second terminal transmits invitation acceptance feedback information to the data server in response to a determining operation performed by the target social account on the social interaction invitation information.

Still referring to FIG. 19, the interaction entrance configured for accepting or rejecting an invitation, such as an accept key or a reject key may be further presented on the information card. When the target social account or another social account agrees to the invitation, the accept key may be triggered to trigger a determining operation on the social interaction invitation information. The second terminal corresponding to the target social account transmits invitation acceptance feedback information to the data server in response to the determining operation.

In one embodiment, after receiving the social interaction invitation information, the second terminal may confirm whether to accept the invitation. If the second terminal does not accept the invitation, the second terminal may transmit invitation rejection feedback information to the data server. The data server instructs, based on the invitation rejection feedback information, the resource server to delete a corresponding status resource, for example, delete the target status and social status data of the corresponding social relationship chain, to reduce storage pressure. In addition, the data server notifies, based on the invitation rejection feedback information, the target account in the first terminal that the target social account of the second terminal rejects the social interaction invitation (that is, rejects synchronization of social statuses).

Operation 312: The data server transmits a status update notification to the first terminal and the second terminal based on the invitation acceptance feedback information.

After the second terminal accepts the social interaction invitation and transmits the invitation acceptance feedback information to the data server, the data server transmits the status update notification to the first terminal and the second terminal, where the status update notification may carry corresponding social status data (for example, a status identifier of a corresponding social status and a corresponding second virtual image). The first terminal and the second terminal display interaction communication establishment indication information according to the social status data. As shown in FIG. 19, the second virtual image and status prompt information (for example, mess around) are displayed on a status card as the interaction communication establishment indication information, to indicate that the target social account accepts the social interaction invitation. In this case, a social status of the target social account is set to a target status (for example, “mess around”, to synchronize social statuses) consistent with that of the target account, and a corresponding social relationship (that is, a lady bro relationship) between the target account and the target social account is established.

When the user triggers the status card, in response to a trigger operation on the status card, a details interface of the status card is displayed, and a target status (for example, “mess around”) of a target social account and a target account, a second virtual image for representing that a lady bro relationship is established between the target social account and the target account, and an interaction control are displayed in the details interface. By using the interaction control, interaction, for example, by transmitting an expression element, with the second virtual image displayed on the status card may be performed. In addition, a release control for releasing a social relationship is further displayed, and a social relationship established between a target social account and a target account may be released (for example, a lady bro relationship is released) by using the release control.

In addition, the virtual images presented in the status presentation areas of the first terminal and the second terminal are updated. For example, in the second terminal, a current social status of the target social account is set to a target status, and a second virtual image corresponding to the target status is presented in the status presentation area. In the first terminal, presentation of the first virtual image corresponding to the target status is replaced with presentation of the second virtual image, to reflect that the social status of each of the target social account and the target account is the target status (for example, “mess around”), and a corresponding social relationship (that is, a lady bro relationship) is established between the target account and the target social account.

In the foregoing manner, a user may edit a social status through customization and generate a corresponding virtual image, that is, may generate a virtual image corresponding to a target status through customization in a social status presentation application, thereby increasing flexibility of generating a virtual image, improving a virtual image generation speed, and bringing richer state interaction content to the user. In addition, another social account may be invited, by using a social interaction control, to establish a social relationship with the target account in the target status, and when the target social account receives a social interaction invitation of the target account, the first virtual image of the target account is replaced with the second virtual image. Because the second virtual image is configured to indicate that a corresponding social relationship is established between the target account and the target social account, when the target social account receives the social interaction invitation of the target account, the social status of the target social account may be automatically set to the target status the same as that of the target account, and social statuses of a plurality of persons such as the target social account and the target account (that is, being both in the target status) may be presented by using the second virtual image, thereby increasing interactivity based on the social status. Because the first virtual image and the second virtual image both correspond to the target status, virtual image elements are added to a social status presentation application, thereby enriching social status presentation styles, and improving utilization of graphic processing resources.

The social interaction method provided in the embodiments of this application has been described with reference to the application and implementation of the electronic device provided in the embodiments of this application. The following continues to describe a social interaction solution implemented collaboratively by modules in a social interaction apparatus 555 provided in the embodiments of this application.

When being applied to a social invitation initiating party, the social interaction apparatus includes: a first display module 5551, configured to display a status presentation area of a target account, the status presentation area being configured for presenting a social status of the target account; a second display module 5552, configured to present, in response to a social status of the target account being a target status, a first virtual image corresponding to the target status and a social interaction control in the status presentation area, the social interaction control being configured to invite at least one social account to establish a social relationship with the target account in the target status; a transmission module 5553, configured to transmit, in response to a social invitation operation on a target social account triggered based on the social interaction control, social interaction invitation information to a terminal corresponding to the target social account; and a replacement module 5554, configured to replace, when the target social account triggers a determining operation on the social interaction invitation information, the first virtual image with a second virtual image corresponding to the target status, the second virtual image being configured to indicate that the social relationship is established between the target account and the target social account in the target status.

In some embodiments, before the first virtual image corresponding to the target status is presented in the status presentation area, the apparatus further includes: a status setting module, configured to: display a status setting control corresponding to the target account; display at least one candidate social status in response to a trigger operation on the status setting control; and set, in response to a selection operation on the target status of the at least one candidate social status, the social status of the target account to the target status.

In some embodiments, the second display module is further configured to: display a status image creation control corresponding to the target account; determine, in response to an information editing operation triggered based on the status image creation control, at least one of the following types of description information corresponding to the information editing operation: text, picture, and audio/video; and set a social status of the target account to a target status in response to a determining operation on the description information, and present a first virtual image corresponding to the target status in the status presentation area, where the target status is determined according to the description information, and the first virtual image is generated based on the description information.

In some embodiments, before the social status of the target account is set to the target status, the apparatus further includes: a status determining module, configured to perform text recognition on the description information, to obtain a recognized text corresponding to the description information, and use the recognized text as the target status of the target account, or extract key information from the recognized text, and use the key information as the target status of the target account; and before the first virtual image corresponding to the target status is presented in the status presentation area, the apparatus further includes: an image determining module, configured to: perform text recognition on the description information, to obtain a recognized text of the description information; perform keyword extraction on the recognized text, to obtain at least one keyword of the recognized text; and invoke a virtual image model according to the keyword to perform image prediction processing, to obtain the first virtual image corresponding to the description information, the virtual image model being obtained through training based on a keyword corresponding to a description information sample and a virtual image associated with the description information sample.

In some embodiments, the image determining module is further configured to: perform expression recognition on an expression element when the description information includes the expression element, to obtain a recognized text configured for representing an intention or a sentiment transferred by the expression element; and extract a visual feature and a semantic feature from the description information when a type of the description information is a picture, perform feature fusion on the visual feature and the semantic feature, to obtain a multi-modal feature, and perform text recognition on the description information based on the multi-modal feature, to obtain a recognized text of the description information; or perform semantic understanding on a key frame of the description information when a type of the description information is audio/video, to obtain a semantic feature, and perform text recognition according to the semantic feature, to obtain a recognized text of the description information.

In some embodiments, the image determining module is further configured to perform, when a type of the description information is a picture, special effect conversion processing on the description information of the picture type, to obtain a corresponding special effect picture, and use the special effect picture as the first virtual image corresponding to the target status.

In some embodiments, before the first virtual image corresponding to the target status is presented in the status presentation area, the image determining module is further configured to: display at least one image label that is in an operable state, the image label being obtained by performing label recognition on the description information, and being configured for indicating an image characteristic of a corresponding virtual image; and obtain, in response to a selection operation on a target image label, the first virtual image conforming to an image characteristic indicated by the target image label.

In some embodiments, the second display module is further configured to: present an initial virtual image corresponding to the target status and a replacement control for replacing the initial virtual image in the status presentation area; determine, in response to an information update operation that is triggered based on the replacement control, description information of at least one of the following types corresponding to the information update operation: text, picture, and audio/video; and replace, in response to a determining operation on the description information, the initial virtual image presented in the status presentation area with the first virtual image, the first virtual image being generated based on the description information.

In some embodiments, the second display module is further configured to: present an initial virtual image corresponding to the target status and a replacement control for replacing the initial virtual image in the status presentation area; display, in response to a trigger operation on the replacement control, at least one candidate virtual image corresponding to the target status, the at least one candidate virtual image including the first virtual image; and replace, in response to a selection operation on the first virtual image, the initial virtual image presented in the status presentation area with the first virtual image.

In some embodiments, the character determining module is further configured to: obtain a status identifier of the target status, and a correspondence between different social statuses and different virtual images; and query the correspondence based on the status identifier, and use a found virtual image as the first virtual image corresponding to the target status.

In some embodiments, the second display module is further configured to present, when at least two types of social relationships are provided, social interaction controls corresponding to the at least two types of social relationships in the status presentation area; and before the social interaction invitation information is transmitted to the terminal corresponding to the target social account, the apparatus further includes: an operation receiving module, configured to: display, in response to a trigger operation on the social interaction control, at least one candidate social account and at least one type of social relationship that are selectable; determine, in response to an account selection operation, a target social account that the account selection operation instructs to select, and determine, in response to a relationship selection operation, a social relationship of a target type that the relationship selection operation instructs to select; and receive, in response to a determining operation on the target social account and the social relationship of the target type, a social invitation operation on the target social account, the social invitation operation being configured for inviting the target social account to establish the social relationship of the target type with the target account in the target status.

In some embodiments, the second display module is further configured to present, when at least two types of social relationships are provided social interaction controls corresponding to the social relationships of the types in the status presentation area, where a one-to-one correspondence exists between the social interaction controls and the types of the social relationships; and the operation receiving module is further configured to: display, in response to a trigger operation on a social interaction control corresponding to a social relationship of a target type, at least one candidate social account that is selectable; determine, in response to an account selection operation, a target social account that the account selection operation instructs to select; and receive, in response to a determining operation on the target social account, a social invitation operation on the target social account, the social invitation operation being configured for inviting the target social account to establish the social relationship of the target type with the target account in the target status.

In some embodiments, the apparatus further includes: a third display module, configured to display selection prompt information when an account quantity of target social accounts that the account selection operation instructs to select does not meet a target quantity corresponding to the social relationship of the target type, where the selection prompt information is configured for prompting to reselect another quantity of target social accounts, and the another quantity is less than the account quantity.

In some embodiments, after the social interaction invitation information is transmitted to the terminal corresponding to the target social account, the apparatus further includes: a fourth display module, configured to present feedback prompt information corresponding to the social interaction invitation information in the status presentation area, the feedback prompt information being configured for prompting to wait for feedback from the target social account on the social interaction invitation information.

An embodiment of this application provides a social interaction apparatus, applied to a social invitation receiving party, and including:
an invitation display module, configured to display, in an interaction interface between a target social account and a target account, social interaction invitation information transmitted by the target account for the target social account,
the social interaction invitation information being configured for inviting the target social account to establish a social relationship with the target account in a target status, and the target status being a current social status of the target account; and
a communication establishment display module, configured to display interaction communication establishment indication information in response to a determining operation performed by the target social account on the social interaction invitation information,
the interaction communication establishment indication information being configured for indicating that a social status of the target social account is set to the target status and establishing the social relationship between the target social account and the target account.

In some embodiments, the invitation display module is further configured to display an information card in the interaction interface between the target social account and the target account, and display, on the information card, the social interaction invitation information transmitted by the target account for the target social account, and a third virtual image, the third virtual image being configured to preview the social relationship established between the target social account and the target account; and correspondingly, the communication establishment display module is further configured to display a status card configured for indicating that the target social account is in the target status, and display the third virtual image on the status card, to use the status card and the third virtual image as the interaction communication establishment indication information.

In some embodiments, the apparatus further includes: a details display module, configured to display a details interface of the status card in response to a trigger operation on the status card, and display an interaction control in the details interface, the interaction control being configured to interact with the third virtual image displayed on the status card.

In some embodiments, before the interaction communication establishment indication information is displayed, the apparatus further includes: an image display module, configured to display, in response to a status viewing operation on the target social account, a fourth virtual image corresponding to a current status of the target social account in a status presentation area of the target social account; and after the interaction communication establishment indication information is displayed, the apparatus further includes: a character replacement module, configured to replace the fourth virtual image with the third virtual image in the status presentation area of the target social account.

In some embodiments, when the social interaction invitation information is further configured for inviting another social account to establish a social relationship with the target account in the target status, the third virtual image is configured to preview the social relationship established between the target social account, the another social account, and the target account; and the communication establishment display module is further configured to display a fifth virtual image on the status card when the another social account triggers a reject operation on the social interaction invitation information, the fifth virtual image being different from the third virtual image, and the fifth virtual image is configured to indicate that the social relationship is established between the target social account and the target account.

The embodiments of this application provide a computer program product. The computer program product includes a computer program or a computer-executable instruction. The computer program or computer-executable instruction are stored in a computer-readable storage medium. A processor of an electronic device reads the computer-executable instruction from the computer-readable storage medium, and the processor executes the computer-executable instruction, to cause the electronic device to perform the social interaction method according to the embodiments of this application.

An embodiment of this application provides a computer-readable storage medium, having a computer-executable instruction or a computer program stored therein, the computer-executable instruction or the computer program, when executed by a processor, causing the processor to perform the social interaction method provided in the embodiments of this application, for example, the social interaction method shown in FIG. 3.

In some embodiments, the computer-readable storage medium may be a memory such as an FRAM, a ROM, a PROM, an EPROM, an EEPROM, a flash memory, a magnetic surface memory, an optical disk, or a CD-ROM; or may be various devices including one or any combination of the foregoing memories.

In some embodiments, the computer-executable instruction can be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer-executable instruction may, but do not necessarily, correspond to a file in a file system, and may be stored in a part of a file that saves another program or other data, for example, be stored in one or more scripts in a Hypertext Markup Language (HTML) file, stored in a file that is specially configured for a program in discussion, or stored in a plurality of collaborative files (for example, be stored in files of one or more modules, subprograms, or code parts).

In an example, the computer-executable instruction may be deployed to be executed on one electronic device, on a plurality of electronic devices located at one site, or on a plurality of electronic devices distributed at a plurality of locations and connected by a communication network.

The foregoing descriptions are only an example of this application and are not intended to limit the scope of protection of this application. Any modification, equivalent replacement, or improvement made within the spirit and scope of this application fall within the protection scope of this application.

What is claimed is:

1. A method for social interactions, the method being performed by an electronic device, and the method comprising:
displaying a status presentation area of a target account, the status presentation area presenting a social status of the target account;
presenting a first virtual image corresponding to a target status and a social interaction control in the status presentation area in response to a social status of the target account being the target status, the social interaction control being configured to invite at least one social account to establish a social relationship with the target account in the target status;
transmitting social interaction invitation information to a terminal corresponding to the target social account in response to a social invitation operation on a target social account triggered by the social interaction control; and
replacing the first virtual image with a second virtual image corresponding to the target status when the target social account accepts the social interaction invitation operation, the second virtual image indicating that the social relationship is established between the target account and the target social account in the target status.

2. The method according to claim 1, wherein before the presenting a first virtual image corresponding to the target status in the status presentation area, the method further comprises:
displaying a status setting control corresponding to the target account;
displaying at least one candidate social status in response to a trigger operation on the status setting control; and
setting the social status of the target account to the target status in response to a selection operation on the target status of the at least one candidate social status.

3. The method according to claim 1, wherein the presenting a first virtual image corresponding to the target status and a social interaction control in the status presentation area in response to a social status of the target account being in a target status comprises:
displaying a status image creation control corresponding to the target account;
determining at least one of the following types of description information corresponding to the information editing operation in response to an information editing operation triggered based on the status image creation control: text, picture, and audio/video; and
setting a social status of the target account to a target status in response to a determining operation on the description information, and presenting a first virtual image corresponding to the target status in the status presentation area,
the target status being determined according to the description information, and the first virtual image being generated based on the description information.

4. The method according to claim 3, wherein before the setting a social status of the target account to a target status, the method further comprises:
performing text recognition on the description information, to obtain a recognized text of the description information, and using the recognized text as the target status of the target account, or extracting key information from the recognized text, and using the key information as the target status of the target account; and
before the presenting a first virtual image corresponding to the target status in the status presentation area, the method further comprises:
performing keyword extraction on the recognized text, to obtain at least one keyword of the recognized text; and
invoking a virtual image model according to the keyword to perform image prediction, to obtain the first virtual image corresponding to the description information,
the virtual image model being obtained through training based on a keyword of a description information sample and a virtual image associated with the description information sample.

5. The method according to claim 4, wherein the performing text recognition on the description information, to obtain a recognized text of the description information comprises:
performing expression recognition on an expression element when the description information comprises the expression element, to obtain a recognized text representing an intention or a sentiment transferred by the expression element; and
extracting a visual feature and a semantic feature from the description information when a type of the description information is a picture, performing feature fusion on the visual feature and the semantic feature, to obtain a multi-modal feature, and performing text recognition on the description information based on the multi-modal feature, to obtain a recognized text of the description information; or
performing semantic understanding on a key frame of the description information when a type of the description information is audio/video, to obtain a semantic feature, and performing text recognition according to the semantic feature, to obtain a recognized text of the description information.

6. The method according to claim 3, wherein before the presenting a first virtual image corresponding to the target status in the status presentation area, the method further comprises:
performing special effect conversion processing on the description information of the picture type when a type of the description information is a picture type, to obtain a special effect picture of the description information of the picture type, and determining the special effect picture as the first virtual image corresponding to the target status.

7. The method according to claim 3, wherein before the presenting a first virtual image corresponding to the target status in the status presentation area, the method further comprises:
displaying at least one image label that is in an operable state, the image label being obtained by performing label recognition on the description information, and indicating an image characteristic of a corresponding virtual image; and
obtaining the first virtual image conforming to an image characteristic indicated by the target image label in response to a selection operation on a target image label.

8. The method according to claim 1, wherein the presenting a first virtual image corresponding to the target status in the status presentation area comprises:
presenting an initial virtual image corresponding to the target status and a replacement control configured to replace the initial virtual image in the status presentation area;
determining description information of at least one of the following types corresponding to the information update operation in response to an information update operation that is triggered based on the replacement control: text, picture, and audio/video; and
replacing the initial virtual image presented in the status presentation area with the first virtual image in response to a determining operation on the description information, the first virtual image being generated based on the description information.

9. The method according to claim 1, wherein the presenting a first virtual image corresponding to the target status in the status presentation area comprises:
presenting an initial virtual image corresponding to the target status and a replacement control configured to replace the initial virtual image in the status presentation area;
displaying at least one candidate virtual image matching the target status in response to a trigger operation on the replacement control, the at least one candidate virtual image comprising the first virtual image; and
replacing the initial virtual image presented in the status presentation area with the first virtual image in response to a selection operation on the first virtual image.

10. The method according to claim 1, wherein before the presenting a first virtual image corresponding to the target status in the status presentation area, the method further comprises:
obtaining a status identifier of the target status, and a correspondence between different social statuses and different virtual images; and
querying the correspondence based on the status identifier, and using a found virtual image as the first virtual image corresponding to the target status.

11. The method according to claim 1, wherein the presenting a social interaction control in the status presentation area comprises:
presenting social interaction controls corresponding to the at least two types of social relationships in the status presentation area when at least two types of social relationships are provided; and
before the transmitting social interaction invitation information to a terminal corresponding to the target social account, the method further comprises:
displaying at least one candidate social account and at least one type of social relationship that are selectable in response to a trigger operation on the social interaction control;
determining a target social account that the account selection operation instructs to select in response to an account selection operation, and determining a social relationship of a target type that the relationship selection operation instructs to select in response to a relationship selection operation; and
receiving a social invitation operation on the target social account in response to a determining operation on the target social account and the social relationship of the target type, the social invitation operation being configured for inviting the target social account to establish the social relationship of the target type with the target account in the target status.

12. The method according to claim 1, wherein the presenting a social interaction control in the status presentation area comprises:
presenting a one-to-one correspondence existing between the social interaction controls and the types of the social relationships when at least two types of social relationships are provided social interaction controls corresponding to the social relationships of the types in the status presentation area; and
before the transmitting social interaction invitation information to a terminal corresponding to the target social account, the method further comprises:
displaying at least one candidate social account that is selectable in response to a trigger operation on a social interaction control corresponding to a social relationship of a target type;
determining a target social account that the account selection operation instructs to select in response to an account selection operation; and
receiving a social invitation operation on the target social account in response to a determining operation on the target social account, the social invitation operation being configured for inviting the target social account to establish the social relationship of the target type with the target account in the target status.

13. The method according to claim 12, further comprising:
displaying selection prompt information when an account quantity of target social accounts that the account selection operation instructs to select does not meet a target quantity corresponding to the social relationship of the target type,
the selection prompt information being configured for prompting to reselect another quantity of target social accounts, and the another quantity being less than the account quantity.

14. The method according to claim 1, wherein after the transmitting social interaction invitation information to a terminal corresponding to the target social account, the method further comprises:
presenting feedback prompt information corresponding to the social interaction invitation information in the status presentation area,
the feedback prompt information being configured for prompting to wait for feedback from the target social account on the social interaction invitation information.

15. A social interaction method, the method being performed by an electronic device, and the method comprising:
displaying social interaction invitation information transmitted by a target account for a target social account in an interaction interface between the target social account and the target account,
the social interaction invitation information being configured for inviting the target social account to establish a social relationship with the target account in a target status, and the target status being a current social status of the target account; and
displaying interaction communication establishment indication information in response to a determining operation performed by the target social account on the social interaction invitation information,
the interaction communication establishment indication information indicating that a social status of the target social account is set to the target status and establishing the social relationship between the target social account and the target account.

16. The method according to claim 15, wherein the displaying social interaction invitation information transmitted by the target account for the target social account in an interaction interface between a target social account and a target account, comprises:
displaying an information card in the interaction interface between the target social account and the target account, and displaying, on the information card, the social interaction invitation information transmitted by the target account for the target social account, and a third virtual image,
the third virtual image being configured to preview the social relationship established between the target social account and the target account; and
the displaying interaction communication establishment indication information comprises:
displaying a status card indicating that the target social account is in the target status, and displaying the third virtual image on the status card, to use the status card and the third virtual image as the interaction communication establishment indication information.

17. The method according to claim 16, further comprising:
displaying a details interface of the status card in response to a trigger operation on the status card, and displaying an interaction control in the details interface,
the interaction control being configured to interact with the third virtual image displayed on the status card.

18. The method according to claim 16, wherein before the displaying interaction communication establishment indication information, the method further comprises:
displaying a fourth virtual image corresponding to a current status of the target social account in a status presentation area of the target social account in response to a status viewing operation on the target social account; and
after the displaying interaction communication establishment indication information, the method further comprises:
replacing the fourth virtual image with the third virtual image in the status presentation area of the target social account.

19. An electronic device, comprising:
a memory, configured to store a computer-executable instruction or a computer program; and
a processor, configured to implement, when executing the computer-executable instruction or the computer program stored in the memory, a method for social interactions, and the method comprising:
displaying a status presentation area of a target account, the status presentation area presenting a social status of the target account;
presenting a first virtual image corresponding to a target status and a social interaction control in the status presentation area in response to a social status of the target account being the target status, the social interaction control being configured to invite at least one social account to establish a social relationship with the target account in the target status;
transmitting social interaction invitation information to a terminal corresponding to the target social account in response to a social invitation operation on a target social account triggered by the social interaction control; and
replacing the first virtual image with a second virtual image corresponding to the target status when the target social account accepts the social interaction invitation operation, the second virtual image indicating that the social relationship is established between the target account and the target social account in the target status.

20. The electronic device according to claim 19, wherein before the presenting a first virtual image corresponding to the target status in the status presentation area, the method further comprises:
displaying a status setting control corresponding to the target account;
displaying at least one candidate social status in response to a trigger operation on the status setting control; and
setting the social status of the target account to the target status in response to a selection operation on the target status of the at least one candidate social status.
